(19) United States
(12) Patent Application Publication
(10) Pub. No.: US 2012/0166132 A1
(43) Pub. Date: Jun. 28, 2012

(54) METHOD AND APPARATUS FOR ANALYZING PHYSICAL CHARACTERISTICS USING USER EQUIPMENT

(75) Inventors: Jan Otto Blom, Lutry (CH); Marc Bailey, Cambridge (GB); Mats Lõnngren, Helsinki (FI); Julian Charles Nolan, Pully (CH)

(73) Assignee: Nokia Corporation, Espoo (FI)

(21) Appl. No.: 12/979,013

(22) Filed: Dec. 27, 2010

(51) Int. Cl. G06F 15/00

(52) U.S. Cl. 702/127

(57) ABSTRACT

A method including determining to sense, using a user equipment, first data related to a physical characteristic associated with a user taken at a first time. The method further including determining to display a result based on an analysis of the first data.

### BACKGROUND

Service providers and device manufacturers (e.g., wireless, cellular, etc.) are continually challenged to deliver value and convenience to consumers by, for example, providing compelling network services. Additionally, various consumer product manufacturers are continually challenged to provide consumers with valuable products that work effectively, and to build brand loyalty with the consumers. The inventors have discovered that user equipment such as mobile devices can be used to facilitate manufacturers in reaching consumers, and to provide consumers with useful and valuable information regarding products available to them on the market. For example, mobile devices can be advantageously used to provide diagnostic information and analysis for various products to better understand the efficacy of such products. The inventors believe that, by allowing consumers to substantiate a link between a product and its performance for themselves, this link will prove to be a very powerful marketing tool that can be used to improve brand loyalty, create greater product differentiation and encourage switching from brands who cannot offer such diagnostics.

### SOME EXAMPLE EMBODIMENTS

Therefore, there is a need for an approach for providing a result of a determination regarding efficacy of a product based on an analysis of data related to a physical characteristic associated with a user taken using a user equipment.

According to one embodiment, a method comprises facilitating a processing of and/or processing (1) data and/or (2) information and/or (3) at least one signal, the (1) data and/or (2) information and/or (3) at least one signal based, at least in part, on the following: determining to sense, using a user equipment, first data related to a physical characteristic associated with a user taken at a first time; and determining to display a result based on an analysis of the first data.

According to another embodiment, an apparatus comprises: at least one processor; and at least one memory including computer program code for one or more programs, the at least one memory and the computer program code configured to, with the at least one processor, cause the apparatus to perform at least the following, determine to sense, using a user equipment, first data related to a physical characteristic associated with a user taken at a first time; and determine to display a result based on an analysis of the first data.

According to another embodiment, a computer -readable storage medium carrying one or more sequences of one or more instructions which, when executed by one or more processors, cause an apparatus to at least perform the following steps: determining to sense, using a user equipment, first data related to a physical characteristic associated with a user taken at a first time; and determining to display a result based on an analysis of the first data.

According to another embodiment, a method comprises facilitating access to at least one interface configured to allow access to at least one service, the at least one service configured to perform at least the following: determining to sense, using a user equipment, first data related to a physical characteristic associated with a user taken at a first time; and determining to display a result based on an analysis of the first data.

According to another embodiment, an apparatus comprises: means for determining to sense, using a user equipment, first data related to a physical characteristic associated with a user taken at a first time; and means for determining to display a result based on an analysis of the first data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-8, 25-32, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a result of a determination regarding efficacy of a product based on an analysis of data related to a physical characteristic associated with a user taken using a user equipment, according to one embodiment;

FIG. 2 is a diagram of the components of a user equipment capable of providing a result of a determination regarding efficacy of a product based on an analysis of data related to a physical characteristic associated with a user taken using the user equipment, according to one embodiment;

FIG. 3 is a flowchart of a process for providing a result of a determination regarding efficacy of a product based on an analysis of data related to a physical characteristic associated with a user taken using a user equipment, according to one embodiment;

FIG. 4 is a flowchart of a process for providing a result of a determination regarding efficacy of a product based on an analysis of data related to a physical characteristic associated with a user taken using a user equipment, according to another embodiment;

FIG. 5 is a flowchart of a process for providing a result of a determination regarding efficacy of a product based on an analysis of data related to a physical characteristic associated with a user taken using a user equipment, according to yet another embodiment;

FIGS. 6A-6F depict a mobile device having a user interface that can be used to help gather data in a process for providing a result of a determination regarding efficacy of a product, according to another embodiment;

FIGS. 7A and 7B depict a mobile device having a user interface that can provide a user with results and advice relating to efficacy of a product, according to another embodiment;

FIG. 8 depicts a mobile device having a user interface that can provide a user with product promotions relating to a product, according to another embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing a result of a determination regarding efficacy of a product based on an analysis of data related to a physical characteristic associated with a user taken using a user equipment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

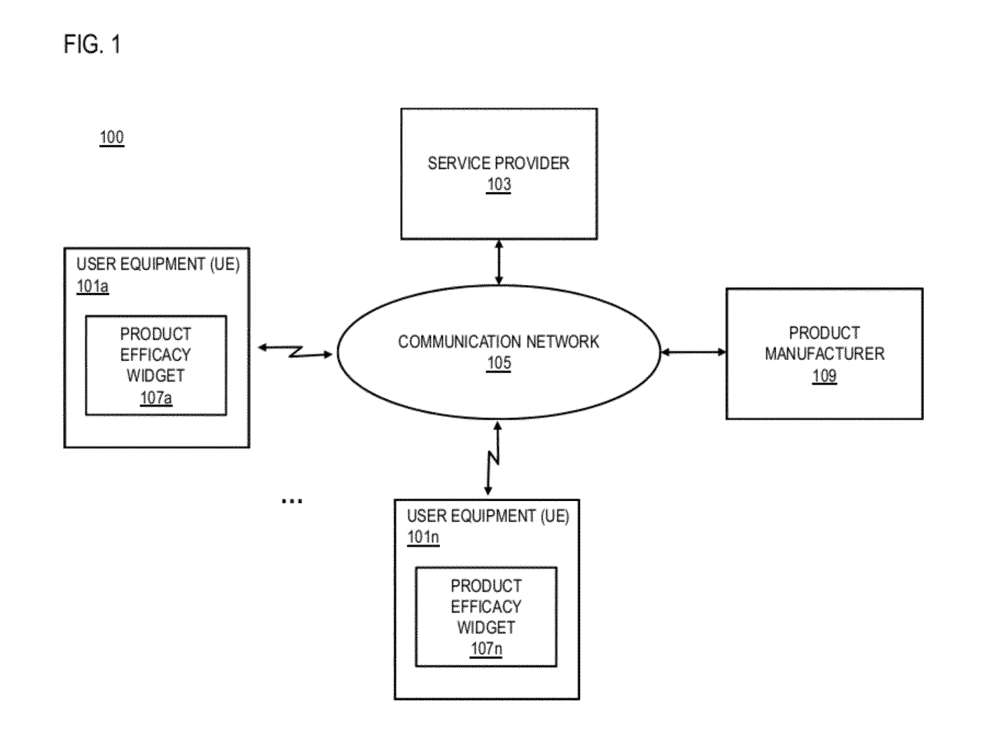

FIG. 1 is a diagram of a system capable of providing a result of a determination regarding efficacy of a product based on an analysis of data related to a physical characteristic associated with a user taken using a user equipment, according to one embodiment. Consumer product manufacturers are continually challenged to provide consumers with valuable products that work effectively, and to build brand loyalty with the consumers. In many instances, consumers are not adequately provided with useful and valuable information regarding products available to them on the market, or a way in which to assess the efficacy of products.

To address this problem, a system 100 of FIG. 1 introduces the capability to providing a result of a determination regarding efficacy of a product based on an analysis of data related to a physical characteristic associated with a user taken using a user equipment. The inventors have discovered that user equipment such as mobile devices can be used to facilitate manufacturers in reaching consumers, and to provide consumers with useful and valuable information regarding products available to them on the market. For example, mobile devices can be advantageously used to provide diagnostic information and analysis for various products to better understand the efficacy of such products. The inventors believe that, by allowing consumers to substantiate a link between a product and its performance for themselves, this link will prove to be a very powerful marketing tool that can be used to improve brand loyalty, create greater product differentiation and encourage switching from brands who cannot offer such diagnostics.

As shown in FIG. 1, the system 100 comprises one or more user equipment (UE), such as UE 101a . . . UE 101n, having connectivity to a service provider 103 via a communication network 105. The UE 101a has a product efficacy widget 107a, and UE 101n has a product efficacy widget 107n. The UEs 101a . . . 101n also have connectivity to a product manufacturer 109 via the communication network. It is noted that while the product efficacy widget is shown as being provided at the UE, the widget and/or functionality thereof can be a web application provided, for example, at a remote server, such as, at the service provider 103.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs can support any type of interface to the user (such as “wearable” circuitry, etc.).

By way of example, the UE 101a . . . UE 101n, service provider 103, and product manufacturer 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The system can provide consumer diagnostics relating to, for example, fast moving consumer goods (FMCG) such as cosmetics, various personal hygiene products, nutritional products, food products, etc., that can allow consumers to better understand the efficacy of their FMCG and nutritional products. By allowing consumers to substantiate the link between a product and its performance for themselves, a very powerful marketing tool is provided that can be used to improve brand loyalty, create greater product differentiation and encourage switching from brands who cannot offer such diagnostics. It also allows FMCG and nutritional product companies to produce products or product programs that are customized to the needs to individual consumers. In the present instance, customization is advantageously provided in combination with the evaluation of the efficacy of products.

UE, such as mobile devices, presently contain one or more sensors (e.g., a camera) that can be used to provide product efficacy evaluations, and mobile device can be provided with additional sensors, such as nanosensors, that can have the ability to measure some of the characteristics which can provide an indication of the efficacy of FMCG, nutritional products, etc. When considered in the context of a mobile device, this can provide a powerful tool for consumer diagnostics for FMCG such as hair products, skin creams, tooth whiteners, etc.

FMCG and nutritional product manufacturers operate in increasingly competitive markets. Consumers presently lack the ability to directly validate the product claims of manufacturers across a large number of FMCG product categories including tooth whitening products, anti-aging creams, shaving products, skin whitening creams, hair products such as shampoos, etc. Many of these products have benefits which are difficult to substantiate directly for the consumer. For example, it is difficult for consumers to measure how much whiter their teeth are over time after using a tooth whitening toothpaste, to understand how a shampoo influences the condition of their hair or whether an anti-wrinkle cream is really working Increasing competition means that FMCG manufacturers stand to gain a powerful competitive advantage if they can conclusive demonstrate the efficacy of their products to consumers, and as a result encourage greater brand loyalty and higher consumption. It also provides a potential opportunity to introduce new products, or programs, which are customized to a consumers needs.

The consumer uses FMCG products to improve their appearance, their wellness status and to adjust (often transiently) their mood and morale by performing a series of actions with FMCG products, for example, reapplying make-up, rearranging hair, eating sweets or chewing gum that change the perception of “mouth-feel” and so on. This invention aims to integrate UE and associated sensors into this behavior cycle to provide advantages such as: the user gains a system that enables them to measure their appearance throughout the day and in multiple locations; the user gains a system that enables them to judge changes in their appearance over time; the user gains a system that provides a measure of the effectiveness of their use of certain FMCG products; (with suitable security and privacy measures in place) the FMCG manufacturers get user feedback on the purchase and usage of their products; a service that links user choice of handset with different FMCG, thereby improving user acquisition and retention; providing the ability for a mobile device service provider to piggy-back on or run joint marketing campaigns with particular FMCG manufacturers; and providing a platform for selling advertising to the user as well as a clear advantage in proving that FMCG manufacturers can use this service as an advertising route by suggesting alternative products to customers.

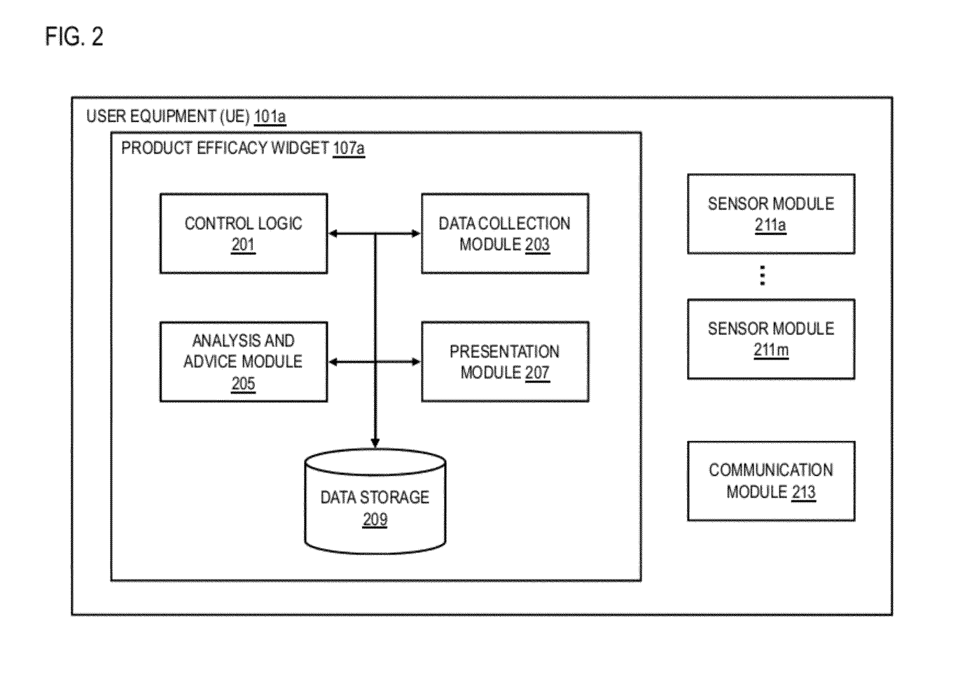

FIG. 2 is a diagram of the components of a user equipment capable of providing a result of a determination regarding efficacy of a product based on an analysis of data related to a physical characteristic associated with a user taken using the user equipment, according to one embodiment. By way of example, the UE 101a includes one or more components for providing a result of a determination regarding efficacy of a product based on an analysis of data related to a physical characteristic associated with a user taken using the UE 101a. It is contemplated that the functions of these components may be combined in one or more components or performed by other components of equivalent functionality.

In this embodiment, the UE 101a includes a product efficacy widget 107a. The product efficacy widget 107a includes a control logic 201, a data collection module 203, an analysis and advice module 205, a presentation module 207, and a data storage 209. The control logic 201 can be used to control and coordinate the operation of the various modules of the product efficacy widget 107a. The data collection module 203 can be used to communicate with various sensor modules 211a . . . 211m incorporated into the UE 101a in order to gather data related to physical characteristics associated with a user of the UE 101a. The analysis and advice module 205 can be used to analyze the data collected in order to determine product efficacy based on appropriate algorithms, and to determine associated advice for the user based on the results of the product efficacy. Such analysis and advice can be performed in the UE 101a, or can be performed by the service provider 103 or product manufacturer 109, for example, via a communication module 213. The presentation module 207, in conjunction with a display on the UE 101a, can provide a user interface for interaction with the user. The data storage 209 can store data gathered, and analysis and advice results.

Thus, a method is provided of operating a mobile computing device for interacting with a user and detecting the efficacy of various products, such as skin, tooth and hair care products, applied by the user. The method can include monitoring the efficacy of the users application of a product by interpreting two or more interactions between the device and the user, storing information relating to the efficacy of the product, and determining a level of performance of the product based either on trends of the stored information or by comparing the stored information to other reference points. Optionally, the method can rely upon a dedicated client on the mobile device which can prompt the user to take measurements, provide additional instructions, include the link to one or more social networking services or/and upload the output of the process to the service provider.

In other words, the method involves the use of a mobile terminal which allows the measurement and evaluation of the efficacy of FMCG, the user's effectiveness of using certain FMCG products, nutritional products, etc. It includes at least one sensor, a processor, and a means to communicate. The mobile terminal takes at least two measurements, using an integrated sensor, of physical characteristic, such as skin or hair characteristics, and then calculates an estimate of the efficacy of the FMCG or nutritional product being used. The efficacy of the product can be measured in terms of skin tone, tooth color, hair care “quality,” breath odor, skin chemistry, etc. depending upon the product whose efficacy is being measured.

Upon calculation of the product efficacy, the result can be integrated with other system features for user profiling or suggested purchases, etc. The method can be expanded and made more specific by integrating the hardware needed, with a method that is related to the context of its use. This can, for example, be to take the product described above, and then to integrate this with existing or new contextual experience methods which will be enabled by the hardware.

Alternatively, the widget can be contained within a product which is connected to a mobile device through an interface such as a wired or wireless communication means (e.g., Bluetooth™, WiFi). In this instance, the UE can be fixed at, for example, the point of sale of FMCGs (e.g., supermarket, pharmacy, etc.) or related services (e.g., hairdresser, spa, etc.).

The method can be applied to measure the performance of a number of FMCG products including, for example: tooth whitening toothpaste, by measuring over time changes in tooth color; skin whitening cream, by measuring over time changes in skin color; anti-aging cream, by measuring over the time changes in skin texture/wrinkles; shaving products, by measuring hair length over time; hair cleaning products such as shampoo, by measuring shampoo or hair secretion residue; hair coloring, by measuring over time changes in color; make-up such as foundation, mascara, and other applied layers that alter the outer appearance of the face and skin; breath freshening products, by measuring characteristics of the breath prior to and after using the product; etc.

The method generally does not focus on addressing user behavior, but rather the performance of specific products used by the user.

The apparatus can be based on a mobile terminal with specific hardware features that is used according to a prescribed method and which is personal to a user, and/or a stand-alone unit. Such a stand-alone unit could contain optical sensors and additional sensing mechanisms, and a means of communicating sensor data to a mobile device through wired or wireless communication. Stand-alone units can be located at the point of sale of FMCGs (e.g., supermarket, pharmacy, etc.) or associated points of sale (e.g., hairdresser, spa, etc.), or even at the home of the user.

The UE 101a of FIG. 2 can be provided as a mobile terminal or mobile device having one or more sensors, such as a CMOS or CCD as part of a camera system. As the technology becomes more prevalent and available, different types of sensors capable of sensing and characterizing skin and hair pH, hair secretions, makeup residues, shampoo residue both chemical and nanoparticulates, saliva constituents, breath odor, etc. can also be added. The UE can also feature at least one illumination source, such as an LED or camera flash, or a display such as an LCD backlight or a self emitting display such as an OLED. The UE can also include the ability to provide an illumination source which operates at one or more specific wavelengths, for example, a color backlit LCD or self emitting OLED. The sensor and source of illumination can be combined in a number of different ways and combined with other sensors added to sense different physical or biological characteristics.

For the performance and efficacy estimation of tooth whitening products, for example, a white LED (such as one used to provide the camera flash function) can be controlled in a defined way so as to illuminate one or more of the users teeth, which can then be imaged using an imaging device with suitable color sensitivity. Optionally, a calibration method can be included to ensure repeatable and robust results. Other illumination methods incorporating different light wavelengths generated by other displays can also be considered if necessary.

For the performance and efficacy estimation of foundation and lipstick, the camera and the flash can be used or, where present a secondary camera (e.g., a camera used for video conferencing facing outward from the display), to get an image of the face from before and after the application of make-up. The image can be used to measure the changes in image features such as contrast and reflectance that correlate with the application of makeup. Image analysis can be performed on the full face or on particular areas such as the lips.

For the performance and efficacy estimation of skin whitening cream, a main or secondary display of the mobile terminal may be controlled in such a way so as to provide the necessary illumination so as to be able to assess the color tone of skin. The resulting reflected light is detected by a sensor, which has sufficient color sensitivity so as to be able to function in this application. Optionally, a calibration method can be included to ensure repeatable and robust results.

For the performance and efficacy estimation of anti-aging cream, a main or secondary display of the mobile terminal can be controlled in such a way so as to provide the necessary illumination so as to be able to assess the texture and structure of skin. The resulting reflected light is detected by a sensor, which has sufficient sensitivity so as to be able to function in this application. Optionally, a calibration method can be included to ensure repeatable and robust results. Optionally, a biosensor can be used to collect further information (e.g., by taking a small sample) on skin dryness, for example.

For the performance and efficacy estimation of shaving products, a main or secondary display of the mobile terminal can be controlled in such a way so as to provide the necessary illumination so as to be able to use an optical sensor to detect likely characteristics of hair growth. A biosensor can be used to detect and interpret skin secretions to further try and determine the efficacy of shaving products. Optionally, a calibration method can be included to ensure repeatable and robust results.

For the performance and efficacy estimation of hair care products, a biosensor can be used to detect hair and scalp secretions in such a way as to be able to measure characteristics that are important to determine the efficacy of hair care products. In this application, a sensor or sensors would measure both the status of the hair and scalp as well the residue of the hair care product for example many conditioners acidify the hair which can be detected with a pH sensor while the shampoo introduces novel surfactants on the hair surface which can be measured chemically, by changes in hair conductance or by changes in the optical properties of the hair such as reflectance. Certain shampoos and sunscreens leave residues of nanoparticles which may be measurable while, over time, the amount of the hair's naturally lubricant, sebum accumulates that can be measured using chemical sensors specific for waxes and specific fatty acids. Optionally, a calibration method can be included to ensure repeatable and robust results.

In usual operation of a mobile terminal, a user will hold the mobile terminal next to their ear, which can bring parts of the mobile terminal into contact with their hair and skin. This makes it possible to use some of the embodiments in an automatic mode, whereby the user does not have to undertake any special or exceptional action to benefit from the functionality proposed. For example, in the skin whitening cream efficacy embodiment the illumination can be provided by the main display (OLED of backlit LCD), and imaging function by an appropriately positioned secondary camera, thereby collecting data during use of the phone. In a further example, for the hair product embodiment, a biosensor can be incorporated in part of the mobile terminal most likely to come into contact with the users hair, scalp or, ears to detect secretions which may allow the efficacy of hair care products to be assessed.

The product efficacy widget can operate in several modes, for example, a systematic mode or a spontaneous mode, or an automatic mode or a manual mode. For example, in a systematic mode, the mobile device can remind a user when to apply FMCG product(s) and measure efficacy. In a spontaneous mode, a user can decide when to measure efficacy and apply FMCG products. Under both modes, measurement can be made automatically in conjunction with normal phone use, or through a dedicated manual step, as prompted by the dedicated client. Measurements are taken and stored over time with the option of on-device or remote storage with appropriate privacy and security measures in place. Resulting time series data can be locally and/or remotely stored, analyzed, and/or displayed. The data collected can be benchmarked against other products, which can include comparisons with competing FMCG products. The resulting data can be interpreted and used to make recommendations and suggestions to the user (e.g., frequency of user, quantity of use, etc.). The mobile device can offer options of providing adverts (e.g., coupons for the product, for a competing product, for related products) or access to additional services (e.g., matching color of make-up with color of clothing, etc.). The systematic mode would generally provide a higher probability of accurate results, than the spontaneous mode.

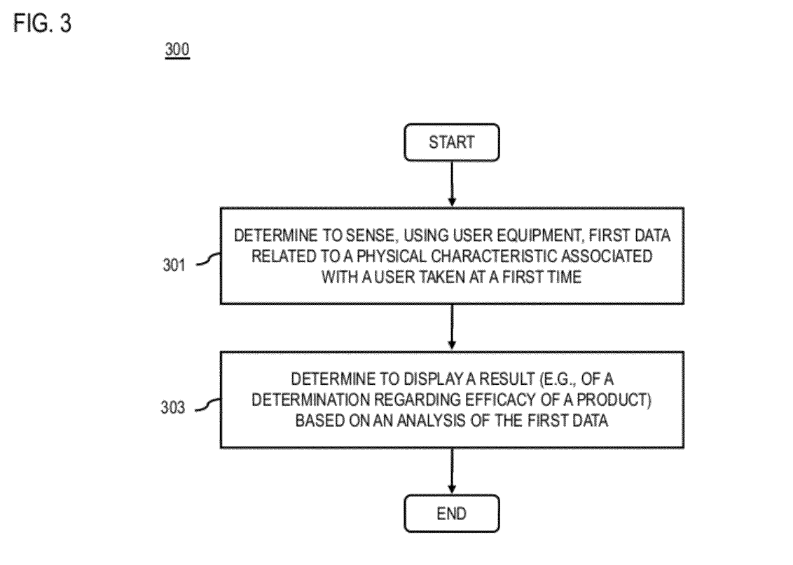

FIG. 3 is a flowchart of a process 300 for providing a result of a determination regarding efficacy of a product based on an analysis of data related to a physical characteristic associated with a user taken using a user equipment, according to one embodiment. Step 301 includes determining to sense, using the UE, first data related to a physical characteristic associated with a user taken at a first time. For example, the product efficacy widget (or, remotely, the service provider or product manufacturer) can determine to use a sensor on the UE to sense a physical characteristic of the user as a first data point at a first time. Then, step 303 includes determining to display a result based on an analysis of the first data. Thus, step 301 can include sensing of first data regarding the user's hair, for example, and then step 303 can include an analysis of the hair data to determine if shampoo nano-particles are still present in the hair, and making a recommendation regarding when to wash the hair next based on the presence (or absence) of such shampoo nano-particles. Alternatively, an additional step can be performed in between steps 301 and 303, which includes determining to sense, using the UE, second data related to the physical characteristic associated with the user taken at a second time. In this instance, step 303 can be a comparison between the first data and the second data. For example, the product efficacy widget (or, remotely, the service provider or product manufacturer) can use the two data points to analyze the efficacy of the product over the period of time between the first time and the second time, and provide the user with a result of the efficacy determination, for example, via a display of the UE.

A sequence of operation can be implemented, for example, by prompting a user to initiate various steps. A graphical user interface of a dedicated mobile client could be used to deliver such prompts. For example, before using an FMCG product, the user can be prompted to take a measurement to establish current state, then after applying the FMCG product, the user can be prompted to take another measurement, and then after applying the FMCG product a second time, the user can be prompted to take yet another measurement. The steps of applying and measuring can be repeated as desired, and an analysis can be requested at any time after at least two measurements have been taken.

At the outset of the method, the UE can be used to identify the product that is being evaluated. For example, the UE can sense a barcode on the product, or a radio-frequency identification (RFID) in order for the widget to obtain information regarding the product for use during the analysis and advice. Thus, when the user initiates the application of the product for the first time, then the product can be identified, and various information regarding the product can be obtained locally or remotely, for example, via a remote server. A database can then be established (e.g., in the data storage 209 of the product efficacy widget 107a) for the product, and the data sensed in relation thereto. Various guidance and instructions regarding the product can be provided to the user, and various alerts can be set in order to aid the user in gathering data.

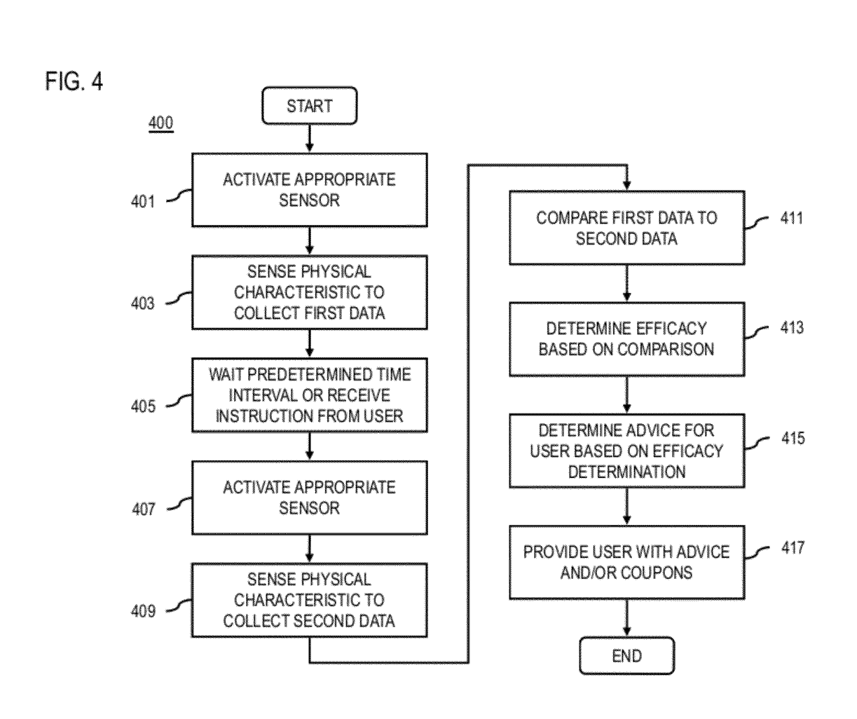

FIG. 4 is a flowchart of a process 400 for providing a result of a determination regarding efficacy of a product based on an analysis of data related to a physical characteristic associated with a user taken using a user equipment, according to another embodiment. In the process 400, an appropriate sensor on the UE is activated in step 401, and the sensor is used to sense a physical characteristic of the user to collect first data in step 403. Then, in step 405, the method waits a predetermined time interval or receives an instruction from a user before moving on to step 407. In step 407, the sensor on the UE is activated, and the sensor is used to sense a physical characteristic of the user to collect second data in step 409. In step 411, a comparison is made between the first data and the second data, and, in step 413, the efficacy of a product is determined based on the comparison, for example, by using the analysis and advice module 205. Additionally, in step 415, advice can be determined for the user based on the efficacy determination, and, in step 417, the user can be provided with advice and/or coupons based on the efficacy determination.

An automatic mode of operation can support most or all of the embodiments. In such an automatic mode, for example, when a user makes a call, the user holds the mobile device to their ear, and an appropriate sensor is automatically triggered to take a first data measurement. The phone will then go into standby or another mode, until the next measurement event occurs, for example, when the phone is next held against the user's ear. When the next measurement event occurs, this will trigger a further measurement, with the time interval between this second and the first measurement being computed. Further measurements are then taken by using the same approach, each tagged with the intervening time interval.

When two or measurements have been taken, the data is used to calculate the efficacy of the FMCG or nutritional product being used by the user over a stated period of time. Product details can be entered manually or by barcode, etc., and the measured efficacy compared to the performance claims of the product manufacturer as far as possible. The efficacy can be calculated according to stored formula and parameters, or such formula and parameters can be downloaded to the mobile device from a remote server, for example, at the service provider or product manufacturer. The efficacy information can be used as part of a broader contextual experience.

The results of the efficacy determination can be displayed to the user automatically or upon request or user setting. The results can provide the user with suggested product usage and care instructions based on the sensed analysis. The results can provide suggested products that can be offered to the user based on the sensed analysis.

Optionally the results can be communicated to other users, for example, as part of a social media program, and/or the results can be provided to the product manufacturers. Communication to the product manufacturers can be made as part of a marketing approach, or alternatively part of a customization program where the manufacturer is able to recommend different products according to the efficacy characteristics of the products which have been used to date. In addition to customized usage programs, information could also be provided to manufacturers to allow products to be customized to the needs of specific users.

The automatic mode of operation is similar to the manual mode, except that in the manual mode the user has to undertake a manual measurement step, for example, as may be advantageous for evaluating certain products, such as tooth whitening products, etc. The measurement step can be undertake spontaneously, or as initiated by a reminder request by the mobile terminal, for example, using an alert reminder such as a sound, a display, a vibration, etc. Also, the widget can provide the user with suggestions regarding when a good time is to perform a sensing operation. For example, the suggestions can include how frequent such sensing operations should be performed, what time of the day is best to perform such sensing operations (e.g., morning, night, etc.), under what conditions such sensing operations should be performed (e.g., prior to brushing teeth, after brushing teeth, prior to eating, after eating, prior to brushing hair, after brushing hair, etc.).

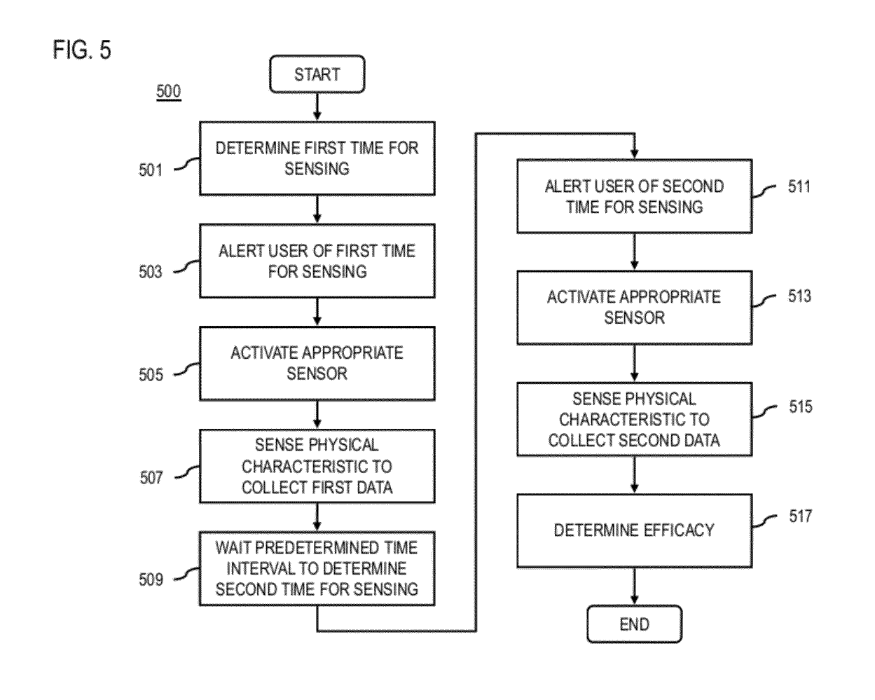

FIG. 5 is a flowchart of a process 500 for providing a result of a determination regarding efficacy of a product based on an analysis of data related to a physical characteristic associated with a user taken using a user equipment, according to yet another embodiment. In the process 500, a first time for sensing is determined in step 501. Once the first time for sensing has arrived, an alert is provided for the user of the first time for sensing in step 503, an appropriate sensor is activated in step 505, and the sensor is used to sense a physical characteristic of the user to collect first data in step 507. Then, in step 509, the method waits a predetermined time interval to determine a second time for sensing. Once the second time for sensing has arrived, an alert is provided for the user of the second time for sensing in step 511, the sensor is activated in step 513, and the sensor is used to sense a physical characteristic of the user to collect second data in step 515. In step 517, the efficacy of a product is determined, for example, based on a comparison between the first data and the second data.

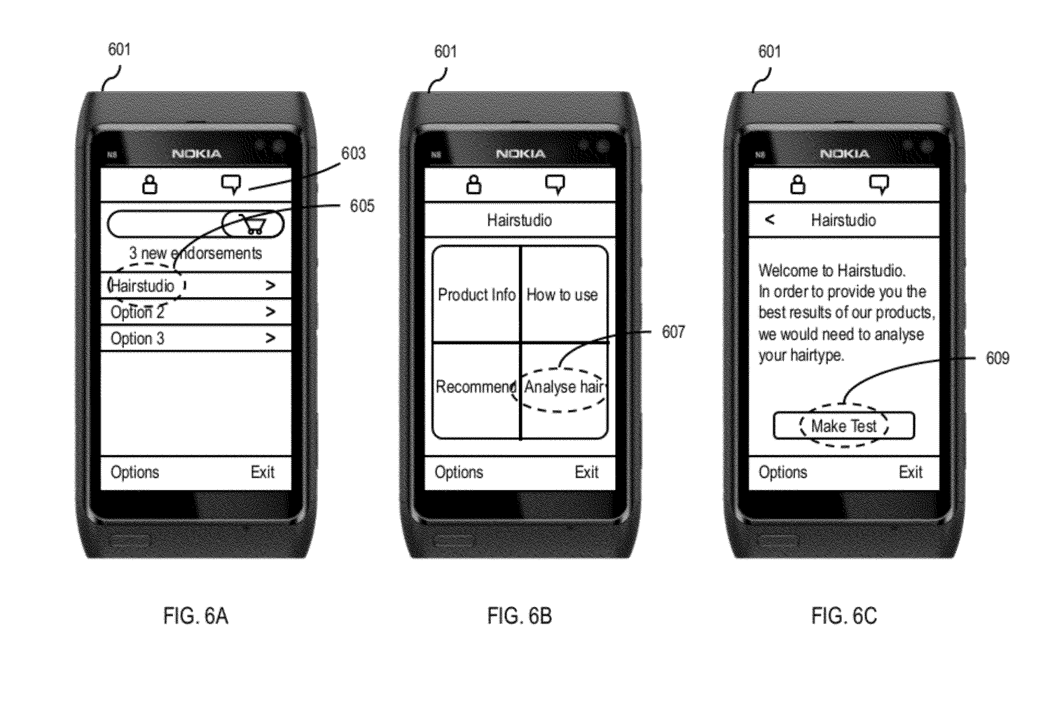

FIGS. 6A-6F depict a mobile device having a user interface that can be used to help gather data in a process for providing a result of a determination regarding efficacy of a product, according to another embodiment. FIG. 6A depicts a user equipment 601 having a display with a user interface 603. The user interface 603 includes a link 605 to a product efficacy widget application, while in this example is titled “Hairstudio.” Upon selecting the link 605, the user interface could display various links, as shown in FIG. 6B, to applications within the product efficacy widget application, for example, product information, how to use the product, recommendations for similar or related products, and a link to actuate an analysis of a user's hair. Thus, by selecting the “Analyse hair” link 607, then the user interface would display various screens that will guide the user through the hair analysis steps, as shown in FIGS. 6C through 6E.

As shown in FIG. 6C, the user interface explains to the user that, in order to provide the user with the best results of the products, the device will need to analyze the user's hairtype. By selecting the “Make test” link 609, the product efficacy widget will then begin a preliminary analysis of the user's hair. As shown in FIG. 6D, the user interface instructs the user to swipe the UE 601 through their hair until an indicator turns to green (shown in FIG. 6E as a filled circle), from an original red color (shown in FIG. 6D as a hollow circle). Alternatively, or in addition to the visual indicator shown in FIGS. 6D and 6E, the UE can provide an alert to the user that the sampling has been completed. For example, the UE can alert the user by making a audible sound or by vibrating, etc. Thus, the UE 601 will activate an appropriate sensor and monitor for detection of the physical characteristic until sufficient data is collected to provide a first data measurement of the physical characteristic, at which time the user interface will show a green indicator and/or activate another alert for the user. The UE 601 can also provide a toggle switch on the user interface to allow the user to select whether the audible alert is activated or not, for example, by tapping or pressing on the red button on the display screen at the outset of the sensing process. Then, in FIG. 6F, the product efficacy widget will provide a product user recommendation to the user, and store the data collected for later use to determine efficacy of the product after the product has been used. Thus, the product efficacy widget can either automatically collect further data at a later time, or alert the user to manually collect such data at a later time, and use the two or more data points collected to provide the user with a product efficacy determination. If manual collection is used, then the user interface can guide the user through the data collection process using interfaces such as shown in FIGS. 6C through 6E, and then provide the user with a product efficacy result in a next user interface screen.

Once the efficacy has been determined, in the case of worse than expected effect, a recommendation could be made regarding how to apply the product in a different way, for example, more frequently. A different product from the same family of products could also be recommended, based on the impact of the original product. The recommendation could be done on a priori basis. Alternatively, the recommendation could be made with the help of a recommender system. Such a recommender system could store data about the impact of various types of products within the given product family on various hair or skin types.

The efficacy determination and recommendations can be varied based on seasonal, regional, and/or individual variations specific to the user. For example, depending on the FMCG product, it is possible that the local weather conditions (e.g., rain and humidity levels) have an impact on the efficacy of the product, in addition to the product itself. For instance, in the case of shampoo, increased exposure to rain might lead to an accelerated decay of the effect of the shampoo, hence resulting in a need to increase the cycle at which the given product is applied.

To account for such variability, the efficacy analysis process as well as FMCG product application instructions could be augmented with extra information about seasonal and regional variations. Such information could comprise, e.g., preinstalled information about rainfall levels in various regions of the world across the months of the year. It is also possible to feed live data about weather conditions to the service based on a location of the mobile device (e.g., as determine using GPS technology, cell phone triangulation, or other location determining methods or devices), in which case the analysis would yield a higher accuracy level.

Individual differences could also interact with the active agents of the FMCG products. For instance, it is conceivable that the effect of a shampoo will reduce relatively fast for individuals who are physically active or outdoors. Physical activity level could be automatically detected with the help of the mobile device, through the use of GPS and accelerometer data. Alternatively, this information could also be directly obtained from another application, such as Nokia SportsTracker™ or Wellness Diary™, or by manual entry of the user.

Across the examples above, information about, for example, recent weather and activity level of the user will yield a more reliable estimate of the effect of the FMCG product, as it leads to more complete knowledge about the values of other relevant parameters.

The outcome of the measurement process can be used in various ways, in addition to communicating about the effect to the user. For instance, the user may be interested in publishing the results on a social networking service. It is also possible to form communities of consumers with similar profiles by correlating performance of the FMCG product across the population. For instance, if Shampoo X has effect Y on certain consumers' hair, then a community can be formed for those diagnosed with effect Y, to provide a social forum for such customers to share suggestions, or for marketing to such groups, etc.

A final example of utilizing the output of the measurement process is related to feedback loop of the efficacy of the FMCG or nutritional product to the manufacturer of the given product. It is conceivable that such information is valuable to the manufacturer as it enables modifications to be made to the chemical composition of the FMCG product. It is also conceivable that competitors of the efficacy measurement would be interested in this kind of information. In any case, phone customers that provide such feedback to manufacturers could be provided with incentives, such as coupons, phone subsidies, free call time, etc. In the case a feedback loop of the efficacy of the FMCG product is created, a need arises to protect the privacy of the individual using the product. For instance, images revealing the face should be made anonymous.

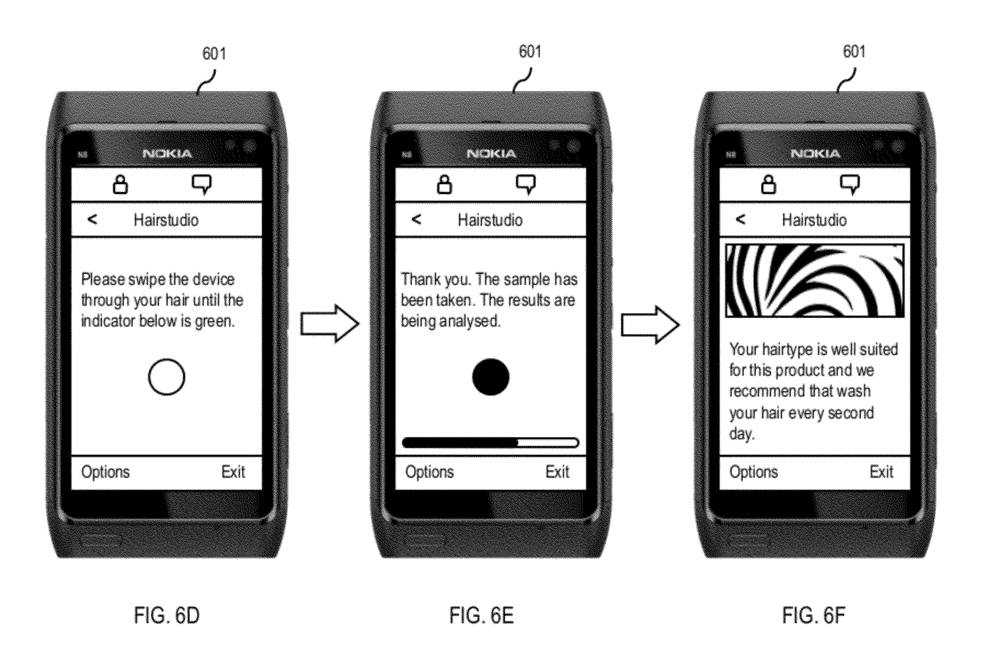

During various stages of the interaction with the application, different types of educational information can be shared with the user, through text based and visual means. For example, a schedule and/or instructions for applying the product can be included in the application. The expected efficacy during various stages of the application period can be included in this information, for example, as depicted in the embodiments shown in FIGS. 7A and 7B. For instance, a diagram showing the hypothesized effect from Day 1 of applying the product can be accompanied with the instructions. Depending on the type of effect that has taken place, scientific explanation for that particular effect can be provided to the user.

FIGS. 7A and 7B depict a mobile device having a user interface that can provide a user with results and advice relating to efficacy of a product, according to another embodiment. In FIGS. 7A and 7B, user equipment 701 is shown that includes a user interface 703 that provides the user with a display of an analysis of a physical characteristic and a product efficacy related thereto, as well as a recommendation regarding further use of the product. In this instance, as shown in FIG. 7A, the product efficacy widget has determined, based on a prior data measurement (e.g., taken just after the previous hair washing) and on a current data measurement, than the effect of the product since the washing is still at 50% effectiveness, and therefore a next wash is recommended in 24 hours. Alternatively, the determination can be based on a single measurement and compared to stored data * * * , for example The embodiment shown in FIG. 7B could be a result of a further data measurement, the result of which indicate that the effect of the product since the washing is only at 5% effectiveness, and therefore a next wash is recommended now. The product efficacy widget could track usage and length of effectiveness, and compare such results to similar measurements using different products, in order to provide the user with additional efficacy information.

In one implementation, the product efficacy widget can be utilized in conjunction with other health applications, for example, Nokia Wellness Diary™ or HealthWallet™.

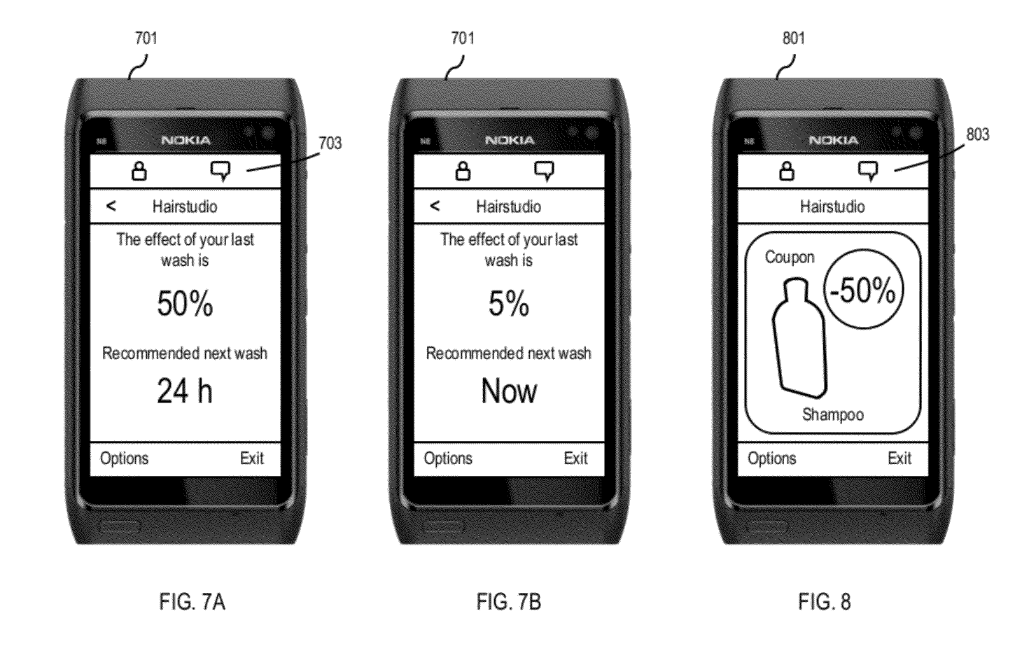

In another implementation, the product efficacy widget can be provided with coupon functionality, for example, by Nokia Money™. For example, an FMCG company wants to promote a new product to the customer. Based on the measured efficacy of product X, say, a shampoo, a new product Y, say, conditioner, is recommended to the user. A digital coupon (see, e.g., FIG. 8) is sent to the mobile client of the user after the measurement process, allowing her to purchase this product for free in a certain store, or at a reduced price.

FIG. 8 depicts a mobile device having a user interface that can provide a user with product promotions relating to a product, according to another embodiment. In FIG. 8, a user equipment 801 is shown that includes a user interface 803 that provides the user with a coupon based on the efficacy of products used, or recommendations for alternative products from the manufacturer or from competing manufacturers, or recommendations for related products or services, etc.

The processes described herein for providing a result of a determination regarding efficacy of a product based on an analysis of data related to a physical characteristic associated with a user taken using a user equipment may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

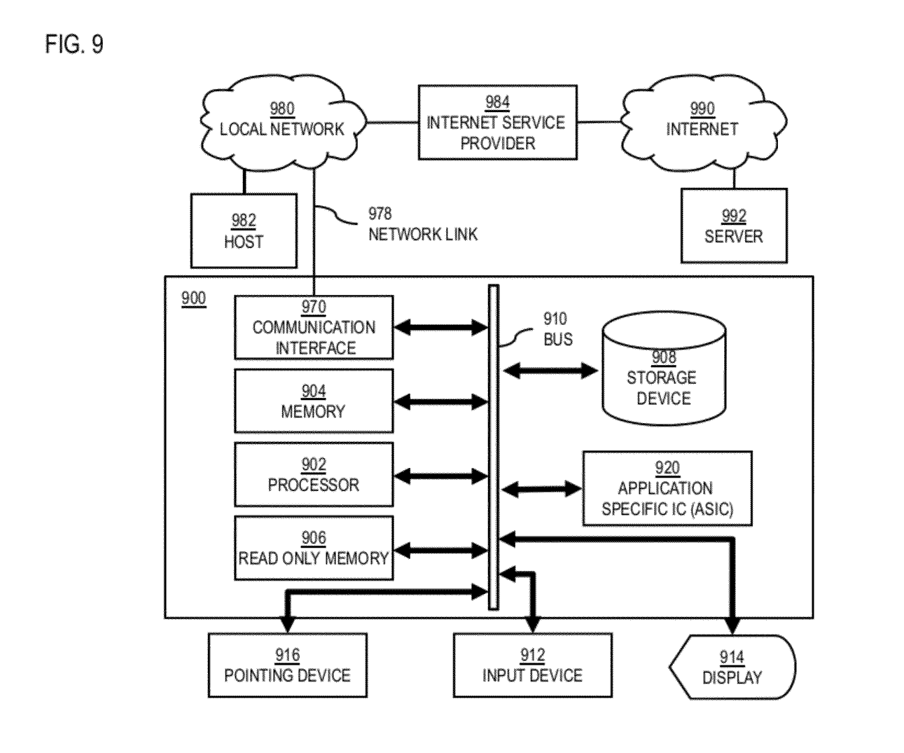

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide a result of a determination regarding efficacy of a product based on an analysis of data related to a physical characteristic associated with a user taken using a user equipment as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing a result of a determination regarding efficacy of a product based on an analysis of data related to a physical characteristic associated with a user taken using a user equipment.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to provide a result of a determination regarding efficacy of a product based on an analysis of data related to a physical characteristic associated with a user taken using a user equipment. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing a result of a determination regarding efficacy of a product based on an analysis of data related to a physical characteristic associated with a user taken using a user equipment. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing a result of a determination regarding efficacy of a product based on an analysis of data related to a physical characteristic associated with a user taken using a user equipment, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing a result of a determination regarding efficacy of a product based on an analysis of data related to a physical characteristic associated with a user taken using a user equipment to the UE 101a . . . UE 101n.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

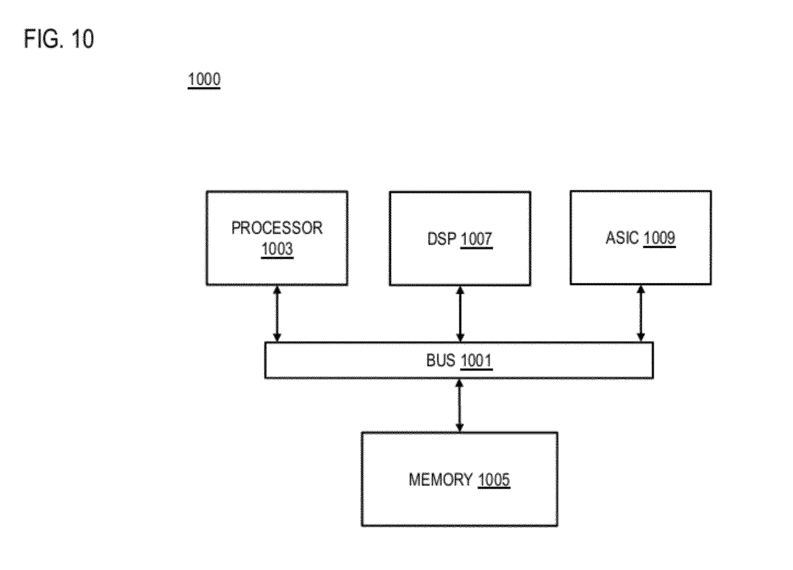

FIG. 10 illustrates a chip set or chip 1000 upon which an embodiment of the invention may be implemented. Chip set 1000 is programmed to provide a result of a determination regarding efficacy of a product based on an analysis of data related to a physical characteristic associated with a user taken using a user equipment as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing a result of a determination regarding efficacy of a product based on an analysis of data related to a physical characteristic associated with a user taken using a user equipment.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide a result of a determination regarding efficacy of a product based on an analysis of data related to a physical characteristic associated with a user taken using a user equipment. The memory 1005 also stores the data associated with or generated by the execution of the inventive steps.

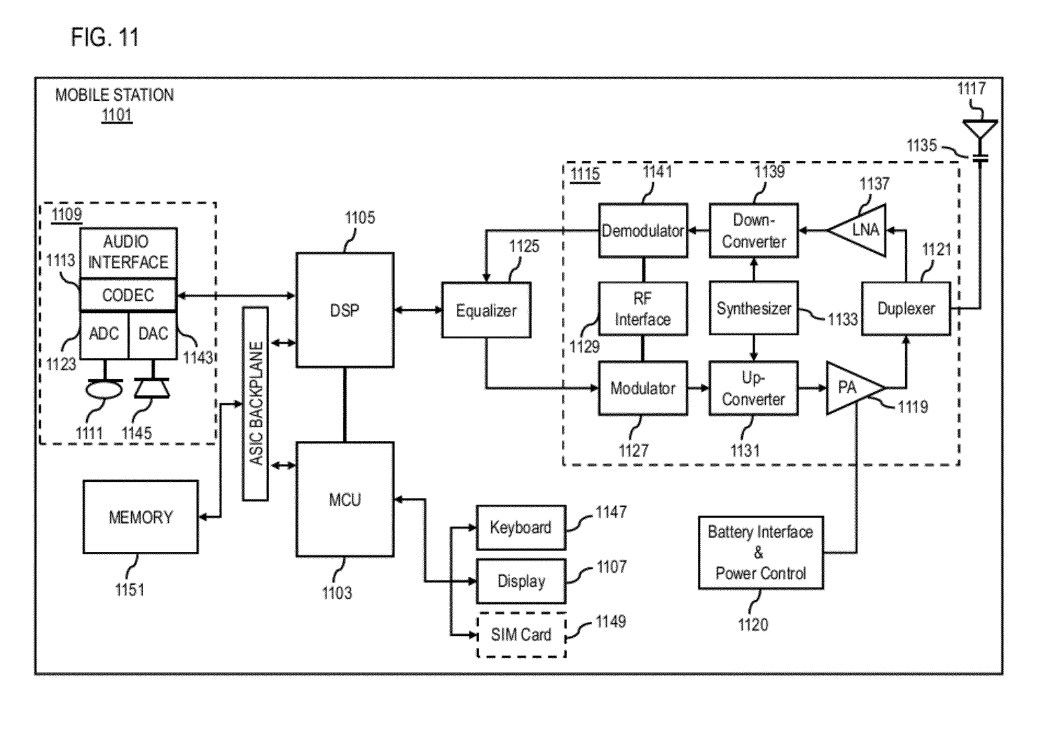

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing a result of a determination regarding efficacy of a product based on an analysis of data related to a physical characteristic associated with a user taken using a user equipment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing a result of a determination regarding efficacy of a product based on an analysis of data related to a physical characteristic associated with a user taken using a user equipment. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide a result of a determination regarding efficacy of a product based on an analysis of data related to a physical characteristic associated with a user taken using a user equipment. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
first data related to a physical characteristic associated with a user taken at a first time, the first data sensed using a user equipment; and
a determination to display a result based on an analysis of the first data.

2. A method of claim 1, wherein the (1) data and/or (2) information and/or (3) at least one signal are further based, at least in part, on the following:
second data related to a physical characteristic associated with a user taken at a second time, the second data sensed using a user equipment,
wherein the result is further based on a comparison between the first data and the second data.

3. A method of claim 2, wherein the result is a determination regarding efficacy of a product based on the comparison between the first data and the second data.

4. A method of claim 3, wherein the (1) data and/or (2) information and/or (3) at least one signal are further based, at least in part, on the following:
a determination to display advice to the user regarding use of the product based at least in part on the result of the determination regarding efficacy of the product.

5. A method of claim 3, wherein the (1) data and/or (2) information and/or (3) at least one signal are further based, at least in part, on the following:
a determination to display advice to the user regarding at least one alternative product based at least in part on the result of the determination regarding efficacy of the product.

6. A method of claim 2, wherein the first data and the second data are determined to be sensed at one or more time periods when the user equipment is in use.

7. A method of claim 2, wherein the (1) data and/or (2) information and/or (3) at least one signal are further based, at least in part, on the following:
a determination to activate alerts at predetermined intervals when the first data and the second data are respectively determined to be sensed.

8. A method of claim 2, wherein the first data and the second data are determined to be transmitted from the user equipment to a server.

9. An apparatus comprising:
at least one processor; and
at least one memory including computer program code for one or more programs,
the at least one memory and the computer program code configured to, with the at least one processor, cause the apparatus to perform at least the following,
determine to sense, using a user equipment, first data related to a physical characteristic associated with a user taken at a first time; and
determine to display a result based on an analysis of the first data.

10. An apparatus of claim 9, wherein the apparatus is further caused to:
determine to sense, using the user equipment, second data related to the physical characteristic associated with the user taken at a second time,
wherein the result is further based on a comparison between the first data and the second data.

11. An apparatus of claim 10, wherein the result is a determination regarding efficacy of a product based on the comparison between the first data and the second data.

12. An apparatus of claim 11, wherein the apparatus is further caused to:
determine to display advice to the user regarding use of the product based at least in part on the result of the determination regarding efficacy of the product.

13. An apparatus of claim 11, wherein the apparatus is further caused to:
determine to display advice to the user regarding at least one alternative product based at least in part on the result of the determination regarding efficacy of the product.

14. An apparatus of claim 10, wherein the first data and the second data are determined to be sensed at one or more time periods when the user equipment is in use.

15. An apparatus of claim 10, wherein the apparatus is further caused to:
determine to activate alerts at predetermined intervals when the first data and the second data are respectively determined to be sensed.

16. An apparatus of claim 10, wherein the first data and the second data are determined to be transmitted from the user equipment to a server.

17. A computer-readable storage medium carrying one or more sequences of one or more instructions which, when executed by one or more processors, cause an apparatus to at least perform the following steps:
determining to sense, using a user equipment, first data related to a physical characteristic associated with a user taken at a first time; and
determining to display a result based on an analysis of the first data.

18. A computer-readable storage medium of claim 17, wherein the apparatus is caused to further perform:
determining to sense, using the user equipment, second data related to the physical characteristic associated with the user taken at a second time,
wherein the result is further based on a comparison between the first data and the second data.

19. A computer-readable storage medium of claim 18, wherein the result is a determination regarding efficacy of a product based on the comparison between the first data and the second data.

20. A computer-readable storage medium of claim 19, wherein the apparatus is caused to further perform:
determining to display advice to the user regarding use of the product based at least in part on the result of the determination regarding efficacy of the product.

21.-48. (canceled)
